(19) United States
(12) Patent Application Publication
(10) Pub. No.: US 2020/0149762 A1
(43) Pub. Date: May 14, 2020

(54) Biosafety Cabinet and Inspection Method of Exhaust Duct Connection

(71) Applicant: Hitachi Industrial Equipment Systems Co., Ltd., Chiyoda-ku, Tokyo (JP)

(72) Inventors: Keiichi ONO, Tainai (JP); Tomoyuki SUZUKI, Tainai (JP)

(21) Appl. No.: 16/625,859

(22) PCT Filed: May 22, 2018
(86) PCT No.: PCT/JP2018/019570

§ 371 Date: Dec. 23, 2019

(30) Foreign Application Priority Data
Oct. 13, 2017 (JP) 2017-199131

(51) Int. Cl. F24F 11/30; F24F 7/06; F24F 13/02; F24F 3/16; B01L 1/00

(52) U.S. Cl. CPC F24F 11/30; F24F 7/06; F24F 2110/65; F24F 3/1603; B01L 1/50; F24F 13/02

(57) ABSTRACT

To provide a biosafety cabinet that issues a warning if exhaust duct connection is performed in an improper method. There is provided a biosafety cabinet which includes first air purification means for exhausting air, second air purification means for supplying purified air to an operation space, and air blowing means, in which the purified air is supplied from the second air purification means to the operation space and the air is exhausted from the first air purification means, the cabinet including: an opening connected to an exhaust duct that is provided downstream of the first air purification means; pressure detection means or air volume detection means disposed downstream of the first air purification means; a control unit controlling an operation of the air blowing means; and an alarm unit, in which the control unit determines an exhaust duct connection method based on an output of the pressure detection means or the air volume detection means and an operation state of the air blowing means, and in which if the exhaust duct connection method is improper, the alarm unit issues a warning.

### TECHNICAL FIELD

The present invention relates to a technique of inspecting whether or not construction is properly performed and issuing a warning in relation to when air is exhausted outdoors from a biosafety cabinet (name in JIS K3800: Class II biological safety cabinets) that is used for the purpose of preventing a researcher from being infected when pathogens or the like are handled for research.

### BACKGROUND ART

A biosafety cabinet is used to prevent a researcher from being exposed to handled pathogens or the like in research of pathogens or the like and in research and development of medicine. An inlet airflow is to be formed in an operation opening, which is formed in a front surface of an operation space, so as to prevent the researcher from being infected through aerosol or air by pathogens or the like handled in the operation space. Since air enters the biosafety cabinet due to the inlet airflow, a substantial volume of air is exhausted outside the biosafety cabinet after dust including pathogens or the like is removed therefrom by a high efficiency particulate air filter (HEPA filter). When not only exposure to pathogens or the like is prevented but also the pathogens or the like for research are handled in a sterile space, a class II biosafety cabinet is used in which a commonly called sterile operation can be performed by blowing purified air, from which dust is removed by the HEPA filter, into the operation space. As described above, an exhaust HEPA filter and an air blow HEPA filter are used at two locations in the class II cabinet.

In the “Laboratory biosafety manual” published by the World Health Organization (WHO) which describes a method for operating a biohazard countermeasures laboratory including a biosafety cabinet and the like, the type of safety cabinets to be used and methods for exhausting air from safety cabinets which are classified by handled experimental materials are described. When biomaterials are handled, a class II A1 type or a class II A2 type is used, and air of the biosafety cabinet is exhausted into a laboratory in which the biosafety cabinet is disposed. If an experimental material is a small amount of volatile radionuclide or chemical substance, a class II B1 type in which outdoor exhaust is essential, or the class II A2 type which is installed to exhaust air through a thimble connection is used. The thimble connection may be expressed also as a canopy hood or an open duct connection. If an experimental material is a substantial amount of volatile radionuclide or chemical substance, the class II B2 type in which outdoor exhaust is essential is used.

JP 2017-78527 A (Patent Document 1) discloses the background art of the technical field. This publication describes a method for issuing a warning if the air volume of an exhaust duct to which an open duct is connected is improper in a biosafety cabinet from which air is exhausted outdoors through an open duct connection.

### CITATION LIST

### Patent Document

Patent Document 1: JP 2017-78527 A

### SUMMARY OF THE INVENTION

### Problems to be Solved by the Invention

Patent Document 1 describes that in the biosafety cabinet where the open duct is connected, when an exhaust air volume decreases improperly, a warning is issued. Since Patent Document 1 is on the premise that air is properly exhausted outdoors from the class II A2 type biosafety cabinet through the open duct connection, a problem when air is exhausted outdoors from the class II A2 type biosafety cabinet through a sealed duct connection, or a problem when the biosafety cabinet is not alone connected to an exclusive outdoor exhaust system is not taken into consideration.

If air is exhausted outdoors from the class II A1 type or the class II A2 type biosafety cabinet through the sealed duct connection, since there is no open portion in an exhaust port of the biosafety cabinet and a building duct, the exhaust air volume of the biosafety cabinet is dependent on the exhaust air volume of the building exhaust duct. A damper is provided inside the duct to adjust the air volume of the building exhaust duct to the exhaust air volume required to form an effective inlet airflow in an operation opening of the biosafety cabinet; however, if the sealed duct connection is made, a fluctuation of outside air caused by wind in the vicinity of an outdoor exhaust port is transmitted to the operation opening, and the inlet airflow fluctuates. This is an improper phenomenon. The phenomenon cannot be prevented by the damper.

In addition, in the class II A1 type or the class II A2 type, a space upstream of the exhaust HEPA filter and the air blow HEPA filter is shared therebetween. If a biosafety cabinet fan is in a stop state and an outdoor exhaust fan operates, the pressure on an exhaust duct side of the exhaust HEPA filter becomes negative, air is taken into the biosafety cabinet from the exhaust HEPA filter, and the pressure also in the shared space upstream of the exhaust HEPA filter and the air blow HEPA filter becomes negative. If the pressure in the space upstream of the air blow HEPA filter becomes negative, air flows backward through the air blow HEPA filter. If a backflow occurs, dust adheres to an air blow side of the HEPA filter supplying purified air. The dust adheres also to a rectifier plate disposed on an operation space side of the air blow HEPA filter. If the biosafety cabinet is activated, the dust is blown, together with blowing air, into the operation space. In order to avoid such event, it is necessary to synchronize the operation timing of the biosafety cabinet fan with that of the outdoor exhaust fan to which a sealed duct is connected.

In addition, if exhausts from a plurality of the biosafety cabinets are connected to the building exhaust duct by sealed ducts, a space downstream of exhaust ports of the plurality of biosafety cabinets is shared therebetween in the building exhaust duct. If dampers, which are open and closed individually in synchronization with the stop of operation of the biosafety cabinet fans, are not provided downstream of the exhaust ports of the biosafety cabinets and the air volume of the building exhaust duct is not controlled to correspond to the number of the biosafety cabinets in operation, the stop of operation of one biosafety cabinet affects the exhaust air volume of another biosafety cabinet. If the sealed duct connection is made, since the exhaust air volume and the inlet air volume of the biosafety cabinet are equal to each other, an inlet airflow formed in the operation opening which is a basic function is affected.

Even if a damper, which is open and closed in synchronization with the stop of operation of the biosafety cabinet, is provided inside a shared duct, the opening and closing speed of the damper cannot follow the speed of change in air volume which is caused by stopping the operation of the biosafety cabinet fan. In addition, the damper does not correspond to a change in exhaust air volume which is caused by opening and closing a front shutter of a biosafety cabinet having a vertical slide type front shutter.

As described above, if air is improperly exhausted outdoors from the class II A1 type or the class II A2 type biosafety cabinet through the sealed duct connection, it is not possible to obtain the performance of the biosafety cabinet.

An object of the present invention is to provide a biosafety cabinet that issues a warning if exhaust duct connection is performed in an improper method.

### Solutions to Problems

In order to solve the problems, as one example of a “biosafety cabinet” of the present invention, there is provided a biosafety cabinet which includes first air purification means for exhausting air, second air purification means for supplying purified air to an operation space, and air blowing means, in which the purified air is supplied from the second air purification means to the operation space and the air is exhausted from the first air purification means, the cabinet including: an opening connected to an exhaust duct that is provided downstream of the first air purification means; pressure detection means or air volume detection means disposed downstream of the first air purification means; a control unit controlling an operation of the air blowing means; and an alarm unit, in which the control unit determines an exhaust duct connection method based on an output of the pressure detection means or the air volume detection means and an operation state of the air blowing means, and in which if the exhaust duct connection method is improper, the alarm unit issues a warning.

As an example of an “inspection method of an exhaust duct connection of a biosafety cabinet” of the present invention, there is provided an inspection method of an exhaust duct connection of a biosafety cabinet which includes first air purification means for exhausting air, second air purification means for supplying purified air to an operation space, and air blowing means, in which the purified air is supplied from the second air purification means to the operation space and the air is exhausted from the first air purification means, the method including: a step of detecting a pressure or an air volume downstream of the first air purification means with pressure detection means or air volume detection means, which is disposed downstream of the first air purification means, when an operation of the air blowing means stops; a step of determining that a sealed duct connection is made, if a pressure detected by the pressure detection means decreases below a predetermined pressure threshold value or if an air volume detected by the air volume detection means increases above a predetermined threshold value; and a step of issuing a warning to indicate an exhaust duct connection method is improper.

In addition, as another example of an “inspection method of an exhaust duct connection of a biosafety cabinet” of the present invention, there is provided an inspection method of an exhaust duct connection of a biosafety cabinet which includes first air purification means for exhausting air, second air purification means for supplying purified air to an operation space, and air blowing means, in which the purified air is supplied from the second air purification means to the operation space and the air is exhausted from the first air purification means, the method including: a step of decreasing or increasing an output of the air blowing means for a predetermined time within a predetermined time from an activation of the air blowing means, and then returning the output back to an output before change; a step of detecting a pressure or an air volume downstream of the first air purification means with pressure detection means or air volume detection means disposed downstream of the first air purification means; a step of determining an exhaust duct connection method by comparing a change in an output of the pressure detection means or a change in an output of the air volume detection means with a change in the output of the air blowing means and by determining whether or not the change in the output of the pressure detection means or the change in the output of the air volume detection means follows the change in the output of the air blowing means; and a step of issuing a warning if the exhaust duct connection method is improper.

### Effects of the Invention

According to the present invention, it is possible to provide a biosafety cabinet which issues a warning to indicate that an improper exhaust duct connection method is made, at an initial stage of installation of the biosafety cabinet when the biosafety cabinet is used in an outdoor exhaust method.

### BRIEF DESCRIPTION OF THE DRAWINGS

FIG. 1A is an example of a side cross-sectional structure view of a biosafety cabinet of Example 1.

FIG. 1B is an example of an appearance front view of the biosafety cabinet of Example 1.

FIG. 2A is an example of a side cross-sectional structure view where the biosafety cabinet of Example 1 is connected to an exclusive outdoor exhaust duct by an open duct connection.

FIG. 2B is an example of a cross-sectional structure view where the biosafety cabinet of Example 1 is connected to the exclusive outdoor exhaust duct by the open duct connection.

FIG. 3 is an example of a cross-sectional structure view where two biosafety cabinets of Example 1 are connected in common to an outdoor exhaust duct by a sealed duct connection.

FIG. 4 is a control block diagram of the biosafety cabinet of the present invention.

FIG. 5 is an example of a flowchart for determining an outdoor exhaust duct connection method of Example 1.

FIG. 6 is an example of a flowchart for determining an outdoor exhaust duct connection method of Example 2.

FIG. 7 is an example of a flowchart for determining an outdoor exhaust duct connection method of Example 3.

FIG. 8 is an example of a flowchart for determining outdoor exhaust through the sealed duct connection of Example 4 based on a pressure.

FIG. 9 is an example of a flowchart for determining outdoor exhaust through the sealed duct connection of Example 5 based on an air volume.

### MODE FOR CARRYING OUT THE INVENTION

Hereinbelow, examples of the present invention will be described with reference to the drawings. Incidentally, in each drawing for describing the examples, as far as possible, the same names and reference signs will be assigned to the same configuration elements, and the repeated descriptions thereof will be omitted.

### EXAMPLE 1

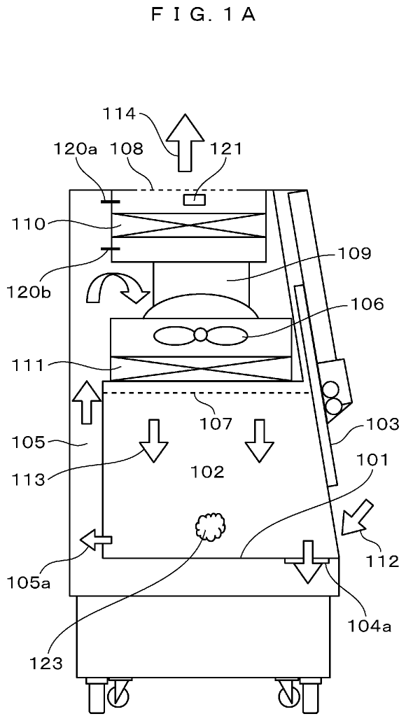

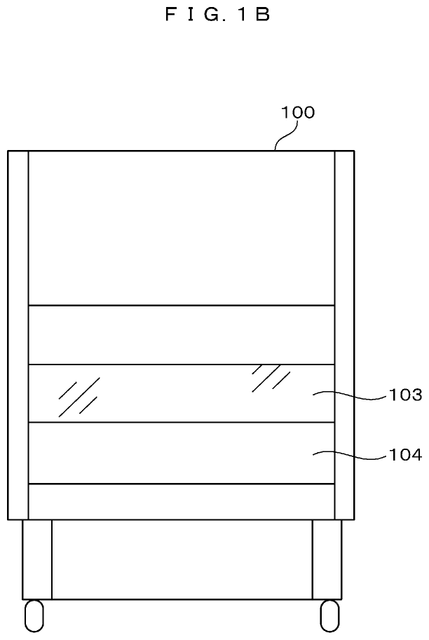

FIG. 1A is an example of a side cross-sectional structure view of a biosafety cabinet of Example 1.

FIG. 1B is an example of an appearance front view of the biosafety cabinet of Example 1.

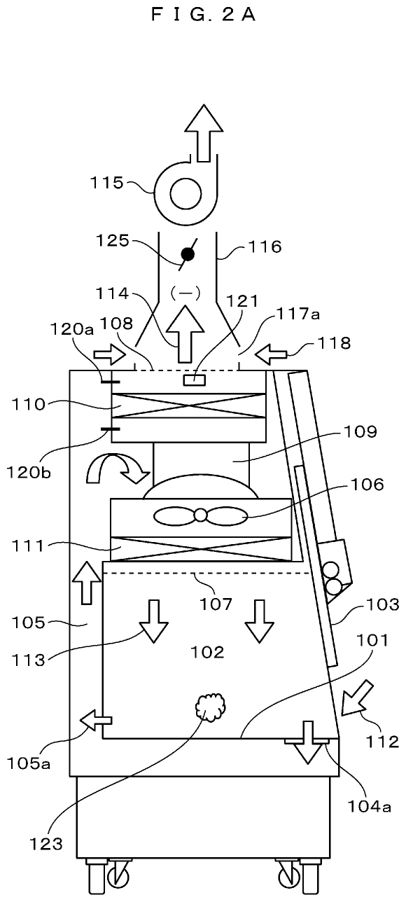

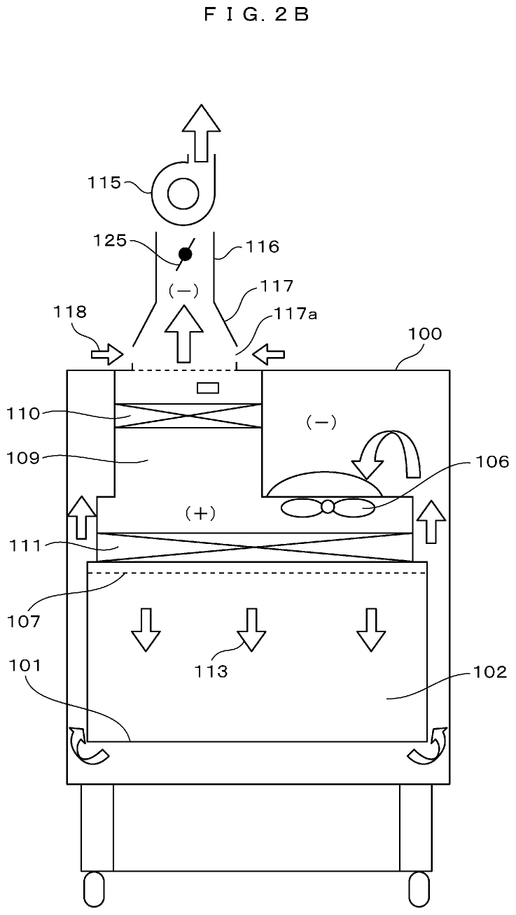

FIG. 2A is an example of a side cross-sectional structure view where the biosafety cabinet of Example 1 is connected to an exclusive outdoor exhaust duct by an open duct connection.

FIG. 2B is an example of a cross-sectional structure view where the biosafety cabinet of Example 1 is connected to the exclusive outdoor exhaust duct by the open duct connection.

An operation space 102, one surface of which is formed of a front shutter 103, is disposed inside a biosafety cabinet 100. A lower surface of the operation space 102 is an operation bed surface 101, and a front grille 104a is disposed in a portion of the operation bed surface 101, which is close to the front shutter 103. An operation opening 104 is formed below the front shutter 103. If a biosafety cabinet fan 106 operates, a pressure chamber 109 is pressurized. An air blow HEPA filter 111 is connected to the pressure chamber 109. Dust inside the pressure chamber 109 is filtered by the air blow HEPA filter 111, purified air flows out and is rectified by a rectifier plate 107, and thereafter, a rectified flow of the purified air is supplied as a blowing airflow 113 into the operation space 102.

An exhaust HEPA filter 110 also is connected to the pressure chamber 109. Air pressurized in the pressure chamber 109 is filtered by the exhaust HEPA filter 110, and is exhausted as a biosafety cabinet exhaust air 114 from the biosafety cabinet 100 through a biosafety cabinet exhaust port 108. Air of a volume equal to the volume of air exhausted from the biosafety cabinet 100 enters the biosafety cabinet 100. The air is an inlet airflow 112 that is formed in the operation opening 104 below the front shutter 103. The inlet airflow 112 is taken, together with part of the blowing airflow 113 in the operation space 102, into the front grille 104a. The air is taken in, together with part of the blowing airflow 113 from a rear grille 105a formed in a surface of the operation space 102 which is opposite to the front shutter 103, through under the operation bed surface 101, and is taken into the biosafety cabinet fan 106 through a back flow path 105. In FIG. 1A, since a space upstream of the exhaust HEPA filter 110 and upstream of the air blow HEPA filter 111 is shared therebetween in the pressure chamber 109, the biosafety cabinet is equivalent to a class II A1 type or a class II A2 type.

Since dust and an aerosol 123 containing pathogens and the like are handled in the operation space 102, dust and the aerosol 123 containing pathogens and the like exist also inside the back flow path 105 and the pressure chamber 109. When air is supplied to the operation space 102, and when air is exhausted from the biosafety cabinet 100, the dust and the aerosol 123 are removed by the air blow HEPA filter 111 and the exhaust HEPA filter 110.

A user sits in front of the biosafety cabinet 100, inserts the arms into the operation space 102 from the operation opening 104, and performs an experiment while seeing the inside of the operation space 102 through the front shutter 103.

In Example 1, an exhaust HEPA filter downstream pressure measurement port 120a is provided in a space that is surrounded by the exhaust HEPA filter 110 and the biosafety cabinet exhaust port 108 downstream of the exhaust HEPA filter 110. In addition, an exhaust HEPA filter upstream pressure measurement port 120b is provided in a wall surface of the pressure chamber 109 upstream of the exhaust HEPA filter 110. If a differential pressure gauge 120 (not illustrated) is connected to the exhaust HEPA filter downstream pressure measurement port 120a and the exhaust HEPA filter upstream pressure measurement port 120b, it is possible to measure an operating differential pressure of the exhaust HEPA filter 110 when the biosafety cabinet fan 106 operates.

An air volume sensor 121 is disposed in a space downstream of the exhaust HEPA filter 110 and upstream of the biosafety cabinet exhaust port 108. An air volume or an air speed may be detected, and instead of the air volume sensor 121, an air speed sensor may be used as far as being able to quantitatively output a speed at which air flows. There are various methods such as outputting electrical signals or the like by using a temperature change caused by cooling effect of air and electrical characteristics, or outputting electrical signals by using ultrasound. The important performance of the biosafety cabinet 100 is a state of the inlet airflow 112 formed in the operation opening 104. Since the volume of air entering the biosafety cabinet 100 is equal to the volume of air output from the biosafety cabinet 100, it is possible to estimate a change in the inlet airflow 112 based on an output of the air volume sensor 121 disposed downstream of the exhaust HEPA filter 110.

A method for exhausting air in the biosafety cabinet 100 into a laboratory where the biosafety cabinet 100 is disposed is illustrated in FIGS. 1A and 1B. The biosafety cabinet fan 106 has a capability of exhausting air in a state where an external static pressure at the position of the biosafety cabinet exhaust port 108 is 0 Pa. Accordingly, when the air in the biosafety cabinet 100 is exhausted into the laboratory, as far as the exhaust port 108 is not blocked, the state of exhausting does not affect the properties of the inlet airflow 112.

FIGS. 2A and 2B illustrate structure views where the biosafety cabinet 100 of Example 1 is connected to the exclusive outdoor exhaust duct by the open duct connection as indicated in the “Laboratory biosafety manual” published by WHO.

If the open duct connection is made, when the exhaust volume of the biosafety cabinet 100 is presumed to be 100%, it is necessary to set the volume of air, which is exhausted from a building exhaust duct 116 by a building exhaust fan 115, at approximately 150%. The air volume is adjusted by a damper 125 installed inside the duct, such that an open duct opening intake air 118 is properly formed in an open duct opening 117a. Since the biosafety cabinet 100 exhausts air in a state where the external static pressure at the biosafety cabinet exhaust port 108 is 0 Pa, fluctuations in the air volume inside the building exhaust duct 116 correspond to fluctuations in the open duct opening intake air 118, and thus there is no fluctuation in the exhaust volume of the biosafety cabinet 100. Accordingly, it is possible to maintain the state of the inlet airflow 112. The “Laboratory biosafety manual” published by WHO describes that the performance of a biosafety cabinet where an open duct is connected is not all affected by fluctuations in building airflow.

It is verified whether or not an open duct 117 is effectively functioning, during construction, by operating the biosafety cabinet 100 and the building exhaust fan 115 and visualizing the formation of the open duct opening intake air 118 in the form of airflow by using a smoke pipe. If a small amount of volatile radionuclide or chemical substance is used for an experiment in the biosafety cabinet 100, air is exhausted from the open duct 117. The volatile radionuclide passes through a HEPA filter. If there occurs the problem that the volatile radionuclide passes through the exhaust HEPA filter 110 to leak into the laboratory and the concentration of the volatile radionuclide increases, the volatile radionuclide is exhausted outside the laboratory through the open duct 117.

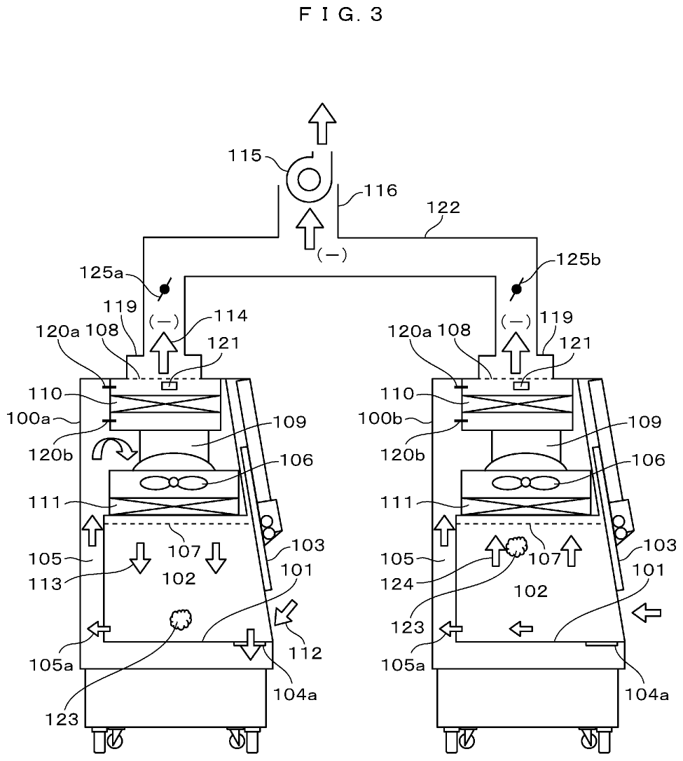

FIG. 3 is an example of a cross-sectional structure view where two biosafety cabinets of Example 1 are connected in common to an outdoor exhaust duct by a sealed duct connection.

FIG. 3 is an improper example where exclusive outdoor exhaust ducts are not used for class II A2 type biosafety cabinets and two biosafety cabinets are connected to a shared duct 122 by sealed ducts 119. The building exhaust fan 115 is required to have the performance to deal with the biosafety cabinet exhaust air 114 of a volume equivalent to that of two units. When the biosafety cabinet fans 106 of two biosafety cabinets 100 operate, if the building exhaust fan 115 having an exhaust air volume capacity equivalent to that of two biosafety cabinets operates, it is possible to secure a volume of the inlet airflow 112 required by two biosafety cabinets.

Even though a biosafety cabinet 100a is in operation and a biosafety cabinet 100b is in a stop state, the building exhaust fan 115 operates at the exhaust air volume of two units. Since the shared duct 122 is connected in a sealed manner to the biosafety cabinet exhaust port 108 of the biosafety cabinet 100b in a stop state, a small volume of air is taken in from the biosafety cabinet exhaust port 108. The pressure of the sealed duct 119 of the exhaust HEPA filter 110 of the biosafety cabinet 100b in a stop state becomes negative, and air is taken in from the exhaust HEPA filter 110, and thus the pressure in the pressure chamber 109, which is a shared space upstream of the exhaust HEPA filter 110 and the air blow HEPA filter 111, also becomes negative. If the pressure in the space upstream of the air blow HEPA filter 111 becomes negative, air flows backward through the air blow HEPA filter 111. If a backflow occurs, dust adheres to an air blow side of the HEPA filter supplying purified air. A dust 123 adheres also to the rectifier plate 107 that is disposed in a portion of the air blow HEPA filter 111, which is close to the operation space 102. If the biosafety cabinet fan 106 of the biosafety cabinet 100b in a stop state is reactivated, the dust 123 is blown, together with blowing air, into the operation space 102.

Air of an exhaust air volume equivalent to that of two units flows through the sealed duct 119 of the biosafety cabinet 100a in operation. Since the volume of air exhausted from the biosafety cabinet is equal to the volume of air flowing into the biosafety cabinet, the volume of the inlet airflow 112 into the biosafety cabinet 100a in operation is greater than an air volume where the performance is verified. In addition, since the space upstream of the exhaust HEPA filter 110 and the air blow HEPA filter 111 is shared therebetween in the pressure chamber 109, the air volume is biased to an exhaust side than to an air blow side. The phenomenon is improper for maintaining the performance of the biosafety cabinet. If two biosafety cabinets 100 have different sizes and different exhaust air volumes, the phenomenon becomes further complicated.

There is a case where two biosafety cabinets 100 are connected to the shared duct 122, and a damper 125a and a damper 125b are provided inside the shared duct 122 to correspond to the biosafety cabinets 100, respectively. However, even though an electric damper is used, the opening and closing speed of the damper cannot follow the speed of change in air volume which is caused by stopping the activation of each of the biosafety cabinet fans 106. In addition, the damper does not correspond to a change in exhaust air volume which is caused by opening and closing a front shutter of a biosafety cabinet having a vertical slide type front shutter. As described above, it is improper to connect a plurality of the biosafety cabinets 100 to the shared duct 122.

If the biosafety cabinet exhaust port 108 is connected to the building exhaust fan 115 via the sealed duct 119, it is necessary to synchronize the operation of the biosafety cabinet fan 106 with the operation of the building exhaust fan 115. The synchronization of operations is the same both when one biosafety cabinet is connected to the building exhaust fan 115 and when a plurality of the biosafety cabinets are connected thereto. If the biosafety cabinet fan 106 is in operation and the building exhaust fan 115 has stopped, the biosafety cabinet exhaust air 114 cannot be exhausted due to resistance of the building exhaust duct 116. Accordingly, the inlet airflow 112 is also not obtained. In addition, if the biosafety cabinet fan 106 has stopped while the building exhaust fan 115 operates, as described with the biosafety cabinet 100b in a stop state in a case where two units are connected to the building exhaust fan 115, the dust 123 flows backward to the operation space 102.

In the case of the open duct 117 illustrated in FIGS. 2A and 2B, the phenomenon can be eliminated by the movement of air through the open duct opening 117a.

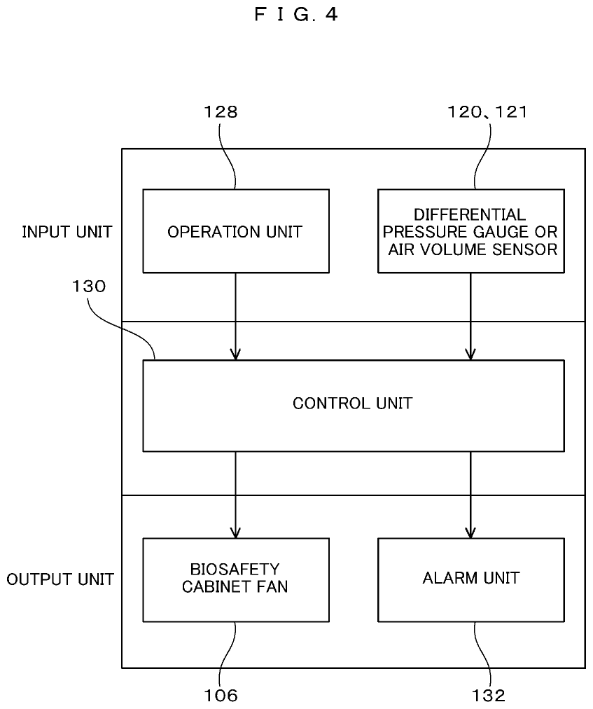

FIG. 4 is a control block diagram of the biosafety cabinet of the present invention.

A user of the biosafety cabinet 100 performs an operation such as turning on an operation switch with an operation unit 128. A control unit 130 controls the biosafety cabinet fan 106 based on information of the operation unit 128. The pressure of the exhaust HEPA filter downstream pressure measurement port 120a is detected by the differential pressure gauge 120, and the pressure information is taken into the control unit 130. In addition, output information of the air volume sensor 121 is taken into the control unit 130. The control circuit 130 determines whether or not the exhaust duct is properly connected, based on the information of the differential pressure gauge 120 or the air volume sensor 121, and an alarm unit 132 issues a warning when a warning is necessary.

There is provided the biosafety cabinet of the present invention which includes first air purification means (the exhaust HEPA filter 110) for exhausting air, second air purification means (the air blow HEPA filter 111) for supplying purified air to the operation space 102, and air blowing means (the biosafety cabinet fan 106), in which the purified air is supplied from the second air purification means to the operation space and the air is exhausted from the first air purification means, the cabinet including the opening 108 connected to the duct that is provided downstream of the first air purification means; pressure detection means (the differential pressure gauge 120) or air volume detection means (the air volume sensor 121) disposed downstream of the first air purification means; the control unit 130 controlling an operation of the air blowing means; and the alarm unit 132, in which the control unit 130 determines a duct connection method based on an output of the pressure detection means or the air volume detection means and an operation state of the air blowing means, and in which if the duct connection method is improper, the alarm unit 132 issues a warning.

A method for inspecting the biosafety cabinet 100 for a problem with the sealed duct connection described above will be described hereinbelow.

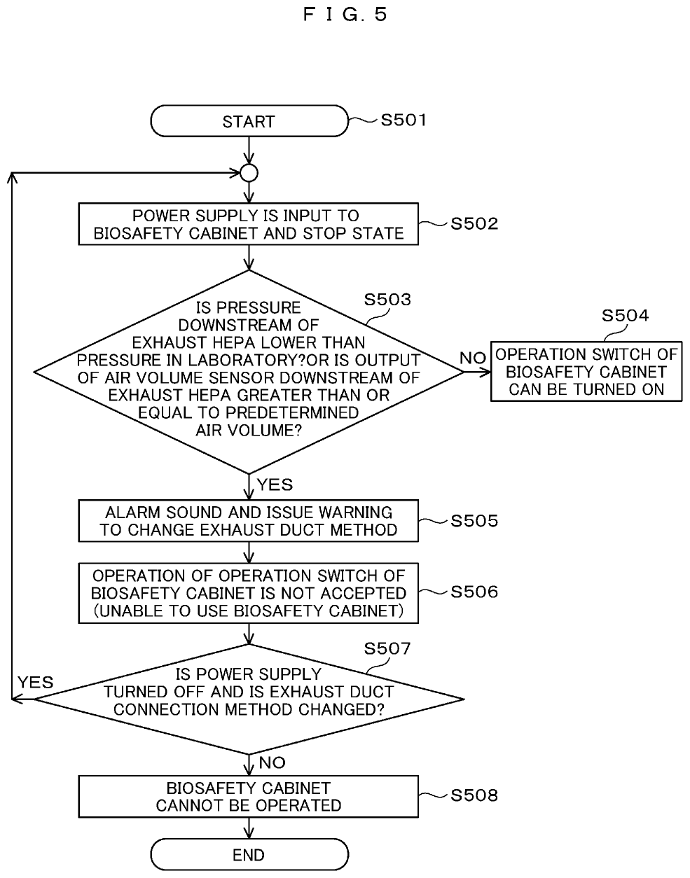

FIG. 5 is an example of a flowchart for determining an outdoor exhaust duct connection method of the biosafety cabinet of Example 1. As an example of improper installation, the biosafety cabinet 100b in a stop state in FIG. 3 will be exemplarily described.

Incidentally, the flowchart is an example of determination of an exhaust duct connection method, which includes part of operations. The flowchart is an example of a determination procedure, and is not a flowchart of operation of the apparatus.

As a premise, the building exhaust fan 115 is in an operation state. The start of determination is initiated (S501). In a state where a power supply is input to the biosafety cabinet and the biosafety cabinet fan 106 stops (S502), it is determined whether or not the pressure downstream of the exhaust HEPA filter 110 is lower by a predetermined threshold value than the pressure of the laboratory in which the biosafety cabinet 100 is disposed, or an air speed or an air volume detected by the air volume sensor 121 disposed downstream of the exhaust HEPA filter 110 is greater than or equal to a predetermined air speed or a predetermined air volume (S503). The pressure downstream of the exhaust HEPA filter 110 in a stop state can be measured at the exhaust HEPA filter downstream pressure measurement port 120a. When the biosafety cabinet fan 106 is in a stop state, since the pressure of the exhaust HEPA filter upstream pressure measurement port 120b is equal to the pressure in the laboratory, it is possible to make a determination based on an indication value (output) of the differential pressure gauge 120 (not illustrated) for the exhaust HEPA filter 110. In regard to the predetermined pressure for determination, since according to JIS 28122 “Contamination Control-Terminology”, a pressure loss of the HEPA filter, specifically, an initial rated pressure loss at a rated flow rate is less than or equal to 245 Pa, if an air volume where the inlet airflow 112 required by the biosafety cabinet can be obtained is approximately 50% of a rated air volume, similarly, also the operating differential pressure of the exhaust HEPA filter 110 becomes approximately 50% of the initial rated pressure loss. Furthermore, when air flows backward at an air volume at approximately 50% of the differential pressure in operation, the differential pressure of the exhaust HEPA filter 110 is a numerical value less than or equal to 61 Pa=245 Pa×50%×50%. In a verification experiment, when the biosafety cabinet fan 106 stops in a state where the open duct 117 is connected and the building exhaust fan 115 operates at an air volume equivalent to 150% of the exhaust volume of the biosafety cabinet 100, the pressure downstream of the exhaust HEPA filter 110 with respect to that of the laboratory is approximately −5 to 8 Pa. Since the value is much different from 61 Pa, it is possible to set the predetermined threshold value at a value of approximately 10 Pa.

Since airflows are moving even when the biosafety cabinet fan 106 stops, a value, which corresponds to the accuracy of the air volume sensor 121 adopted and the volume of air flowing backward due the differential pressure of the exhaust HEPA filter 110 adopted, is selected as a predetermined air volume threshold value of the air volume sensor 121.

If it is determined that when the biosafety cabinet fan 106 stops, the pressure is lower than the pressure of the laboratory or the air volume is greater than or equal to the predetermined threshold value, it is determined that the sealed duct connection is made. In addition, it is determined that in a state where the building exhaust fan 115 is connected to the building exhaust duct 116 via the sealed duct 119 and operates, the operation of the building exhaust fan 115 is not synchronized with the operation of the biosafety cabinet fan 106, or the building exhaust fan 115 is shared with and connected to another exhaust system by the sealed duct connection. Then, a warning for improper construction is issued (S505). The warning may be the display of an abnormality including the display of an indication that the duct connection method is changed from the sealed duct connection method to the open duct connection method or the like, an alarm sound, or the like. Furthermore, an operation of the operation switch of the biosafety cabinet is not accepted (unable to use the biosafety cabinet) (S506).

When a procedure is to be performed, a power supply of the biosafety cabinet 100 is turned off, and the exhaust duct connection method is changed to a duct connection method using the open duct 117 (S507). When a procedure is not to be performed, the state of being unable to operate the biosafety cabinet is maintained (S508).

After the duct connection method is changed to the open duct connection, even though the building exhaust fan 115 operates, since the pressure downstream of the exhaust HEPA filter 110 is lower only by less than 10 Pa than the pressure in the laboratory, air in the laboratory is taken from the open duct opening 117a, and air does not flow backward through the exhaust HEPA filter 110, the determination becomes NO, and it is possible to turn on the operation switch of the biosafety cabinet (S504).

This operation is on the premise that the biosafety cabinet is in a stop state, the biosafety cabinet fan 106 has stopped, and the building exhaust fan 115 operates.

In the biosafety cabinet of the present example, if when the air blowing means (the biosafety cabinet fan 106) stops, a pressure downstream of the first air purification means (the exhaust HEPA filter 110) with respect to a pressure upstream thereof decreases below a predetermined pressure threshold value, or the output of the air volume detection means (the air volume sensor 121) provided downstream of the first air purification means (the exhaust HEPA filter 110) increases above a predetermined threshold value, the control unit 130 determines that a sealed duct connection is made, and the alarm unit 132 issues a warning.

According to the present example, prior to the operation of the biosafety cabinet, it is possible to detect the problem that the outdoor exhaust duct connection is the sealed duct connection, or the problem that when the sealed duct connection is made, the operation of the building exhaust fan is not synchronized with the operation of the biosafety cabinet fan or the building exhaust fan is shared with and connected to another exhaust system by the sealed duct connection, and at an initial stage of installation of the biosafety cabinet, it is possible to issue a warning to indicate that an improper exhaust duct connection is made.

### EXAMPLE 2

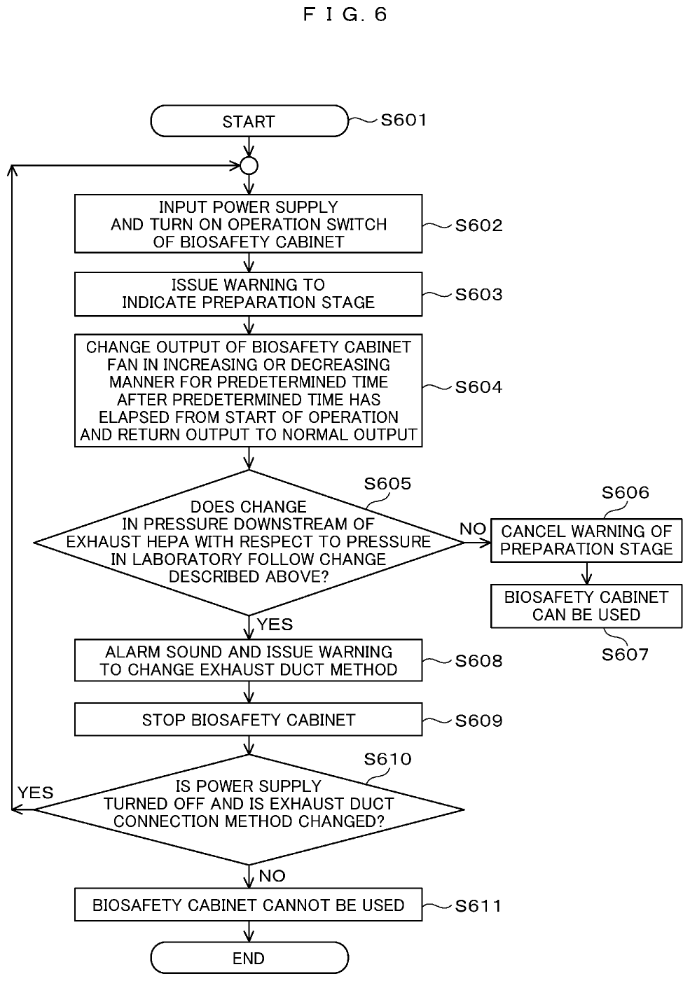

FIG. 6 is an example of a flowchart for determining an outdoor exhaust duct connection method of the biosafety cabinet of Example 2. The flowchart is an example of determination of an exhaust duct connection method, which includes part of operations. The flowchart is an example of a determination procedure, and is not a flowchart of operation of the apparatus.

The start of determination is initiated (S601). The power supply is input to the biosafety cabinet, and the operation switch is turned on (S602). The biosafety cabinet fan 106 is activated, but proper airflows are not immediately formed in the biosafety cabinet 100, and thus a warning to indicate a preparation stage is issued with a display lamp or the like (S603). The “Laboratory biosafety manual” published by WHO instructs that five minutes of a preliminary operation is necessary. The number of five minutes is determined in consideration of the time required that dust in a space such as corners in the operation space 102, in which airflows are stagnant, is eliminated and purified air flows around. As the activation time of the biosafety cabinet fan 106, five minutes is not required. The biosafety cabinet fan 106 reaches an output (the number of revolutions), which is required by the biosafety cabinet 100, in several tens of seconds.

After a predetermined time, for example, 30 seconds, one minute, or the like has elapsed from the start of operation, an output of the biosafety cabinet fan 106 decreases only for seconds to 50% of the output required by the biosafety cabinet, and thereafter, returns back to the output required by the biosafety cabinet (S604). The change in the output may not be 50% but be 30%, 150%, or the like. The definition of after the elapse of the predetermined time from the start of operation includes also zero seconds after the time the operation is instructed. In addition, the time to change the output may be 10 seconds or 20 seconds. After the operation state is returned, airflows may be stabilized in five minutes of the preliminary operation from the start of operation. In this operation, it is easy to change the output (the number of revolutions) by adopting an inverter operation method of a fan motor or a DC brushless motor. As described above, the output is changed on a ratio basis, but may be changed in a method in which the biosafety cabinet fan 106 is reactivated after stop for the moment, specifically, for several tens of seconds. In this case, there is no limitation to the operation method of the fan motor.

It is determined whether the exhaust duct connection method is the open duct connection or the sealed duct connection, based on a difference between the pressure of the exhaust HEPA filter downstream pressure measurement port 120a when the biosafety cabinet fan 106 operates and the pressure of the laboratory in which the biosafety cabinet 100 is disposed (S605). Since the open duct connection has an open portion, fluctuations in building airflow do not affect the biosafety cabinet. Similarly, also fluctuations in the exhaust air volume of the biosafety cabinet 100 do not affect the pressure of the building exhaust duct. Furthermore, since an air volume is delivered to the open duct 117 in a state where the external static pressure at the biosafety cabinet exhaust port 108 is 0 Pa, even though the exhaust volume (output) of the biosafety cabinet 100 is changed and the pressure downstream of the exhaust HEPA filter is changed by a trial, there is no large change in pressure due to air entering and exiting the open duct opening 117a.

If the sealed duct 119 is connected to the biosafety cabinet exhaust port 108, regardless that the air volume capacity of the building exhaust fan 115 satisfies the air volume capacity required by the biosafety cabinet 100, there is no air entering and exiting a connection portion of the sealed duct 119. Therefore, fluctuations in the exhaust air volume of the biosafety cabinet 100 (fluctuations in the output of the biosafety cabinet fan 106) follow fluctuations in the pressure downstream of the exhaust HEPA filter with respect to the pressure in the laboratory.

If the fluctuations in the pressure downstream of the exhaust HEPA filter with respect to the pressure in the laboratory follow the fluctuations in the output of the biosafety cabinet fan 106 which is forcibly changed, it is determined that the sealed duct connection is made, and if no follow relationship is established, it is determined that the open duct connection is made (S605). If a pressure downstream of the exhaust HEPA filter with respect to the pressure in the laboratory before the output of the biosafety cabinet fan 106 is changed is compared with a pressure downstream of the exhaust HEPA filter with respect to the pressure in the laboratory after several seconds from when the output of the biosafety cabinet fan 106 is changed, it is possible to determine whether or not the follow relationship is established.

If due to no follow relationship being established, it is determined that the open duct connection is made, the biosafety cabinet fan 106 continues to operate, and the biosafety cabinet 100 can be used (S607) at a stage where the warning of the preparation stage is cancelled (S606). If due to the follow relationship being established, it is determined that the sealed duct connection is performed, it is determined that construction is improperly performed and a warning is issued (S608), and the biosafety cabinet fan 106 is stopped (S609). The warning may be the display of an abnormality including the display of an indication that the duct connection method is changed from the sealed duct connection method to the open duct connection method or the like, an alarm sound, or the like. The determination can be performed during the time of five minutes of the preliminary operation which is instructed by WHO.

After the power supply is turned off and the exhaust duct connection method is changed to the open duct (S610), the biosafety cabinet can be used based on a re-determination; however, an unusable state of the biosafety cabinet 100 continues if an improper sealed duct connection method is used (S611).

In the biosafety cabinet of the present example, after decreasing or increasing an output of the air blowing means for a predetermined time within a predetermined time from an activation of the air blowing means (the biosafety cabinet fan 106), the control unit 130 returns the output back to an output before change, and if a change in a pressure detected by the pressure detection means (the differential pressure gauge 120) follows a change in the output of the air blowing means, the control unit 130 determines that the sealed duct connection is made, and the alarm unit 132 issues a warning.

According to the present example, it is possible to detect that the outdoor exhaust duct connection is the sealed duct connection at the preparation stage of operation of the biosafety cabinet, and at an initial stage of installation of the biosafety cabinet, it is possible to issue a warning to indicate that an improper exhaust duct connection is made.

### EXAMPLE 3

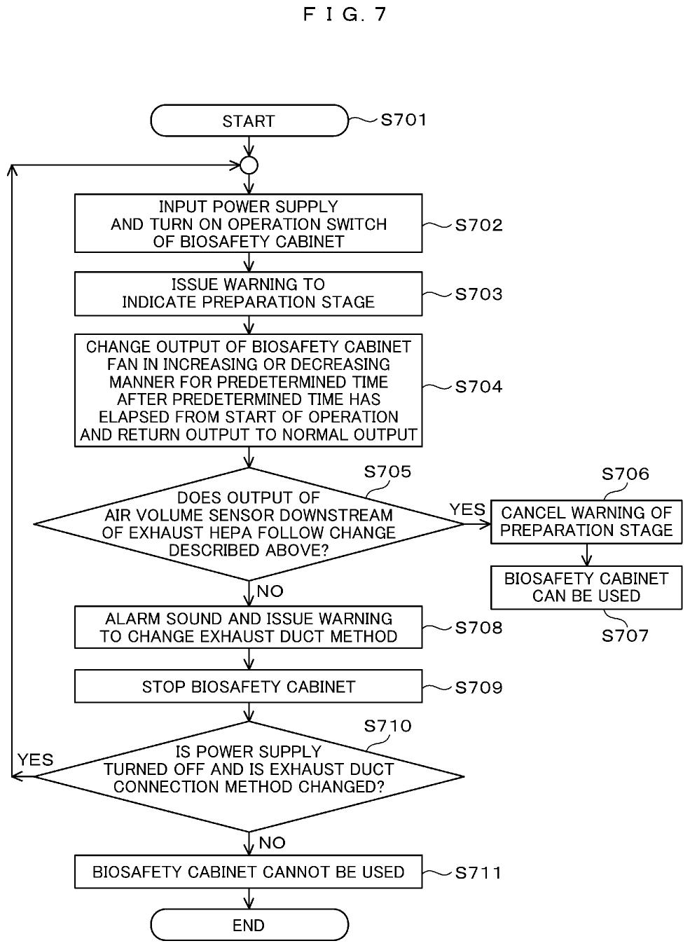

FIG. 7 is an example of a flowchart for determining an outdoor exhaust duct connection method of the biosafety cabinet of Example 3. The flowchart is an example of determination of an exhaust duct connection method, which includes part of operations. The flowchart is an example of a determination procedure, and is not a flowchart of operation of the apparatus.

The start of determination is initiated (S701). The power supply is input to the biosafety cabinet, and the operation switch is turned on (S702). The biosafety cabinet fan 106 is activated, but proper airflows are not immediately formed in the biosafety cabinet 100, and thus similar to Example 2, a warning to indicate a preparation stage is issued with a display lamp or the like (S703).

Similar to Example 2, after a predetermined time, for example, 30 seconds or one minute has elapsed from the start of operation, an output of the biosafety cabinet fan 106 decreases only for 10 seconds to 50% of the output required by the biosafety cabinet, and thereafter, returns back to the output required by the biosafety cabinet (S704). The change in the output may not be 50% but be 30%, 150%, or the like.

It is determined whether the exhaust duct connection method is the open duct connection or the sealed duct connection, based on a change in an output of the air volume sensor 121, which is disposed downstream of the exhaust HEPA filter, when the biosafety cabinet fan 106 operates (S705). Since the open duct connection has the opening and an exhaust air volume is delivered to the building exhaust duct in a state where the external static pressure at the biosafety cabinet exhaust port 108 is 0 Pa, if the output (the number of revolutions) of the biosafety cabinet fan 106 is changed, also the air volume of the biosafety cabinet exhaust air 114 is changed. The air volume of the biosafety cabinet exhaust air 114 is separated from the exhaust air volume of the building exhaust duct by the open duct 117.

If the sealed duct 119 is connected to the biosafety cabinet exhaust port 108, since there is no entering and exiting air, the exhaust air volume of the biosafety cabinet 100 is dominated by the exhaust air volume of the building exhaust fan 115. Therefore, the output of the air volume sensor 121 does not follow fluctuations in the output of the biosafety cabinet fan 106.

If fluctuations in the output of the air volume sensor 121 do not follow the fluctuations in the output of the biosafety cabinet fan 106 which is forcibly changed, it is determined that the sealed duct connection is made, and if the follow relationship is established, it is determined that the open duct connection is made (S705). It is possible to determine whether or not the follow relationship is established, based on an output of the air volume sensor 121 before the output of the biosafety cabinet fan 106 is changed and an output of the air volume sensor 121 after several seconds from when the output of the biosafety cabinet fan 106 is changed.

If due to follow relationship being established, it is determined that the open duct connection is made, the biosafety cabinet fan 106 continues to operate, and the biosafety cabinet 100 can be used (S707) at a stage where the warning of the preparation stage is cancelled (S706). If due to no follow relationship being established, it is determined that the sealed duct connection is performed, it is determined that construction is improperly performed and a warning is issued (S708), and the biosafety cabinet fan 106 is stopped (S709). The warning may be the display of an abnormality including the display of an indication that the duct connection method is changed from the sealed duct connection method to the open duct connection method or the like, an alarm sound, or the like. The determination can be performed during the time of five minutes of the preliminary operation which is instructed by WHO.

If the power supply is turned off and the exhaust duct connection method is changed to the open duct, the biosafety cabinet can be used based on a re-determination; however, an unusable state of the biosafety cabinet 100 continues if an improper sealed duct connection method is used (S711).

As described above, a determination is performed based on the output of the air volume sensor 121; however, since the same movement takes place at the operating differential pressure of the exhaust HEPA filter 110 which is a differential pressure between the exhaust HEPA filter downstream pressure measurement port 120a and the exhaust HEPA filter upstream pressure measurement port 120b, a determination can be performed.

In the biosafety cabinet of the present example, after decreasing or increasing an output of the air blowing means for a predetermined time within a predetermined time from an activation of the air blowing means (the biosafety cabinet fan 106), the control unit 130 returns the output back to an output before change, and if a change in the output of the air volume detection means (the air volume sensor 121) follows a change in the output of the air blowing means, the control unit 130 determines that the sealed duct connection is made, and the alarm unit issues a warning.

According to the present example, it is possible to detect that the outdoor exhaust duct connection is the sealed duct connection at the preparation stage of operation of the biosafety cabinet, and at an initial stage of installation of the biosafety cabinet, it is possible to issue a warning to indicate that an improper exhaust duct connection is made.

Example 2 and Example 3 describe a case where the exhaust duct is connected to the biosafety cabinet exhaust port 108 and construction is performed; however, even though a cargo is placed at the biosafety cabinet exhaust port 108 and air cannot be exhausted from the biosafety cabinet exhaust port 108, a determination can be performed similar to the sealed duct connection.

### EXAMPLE 4

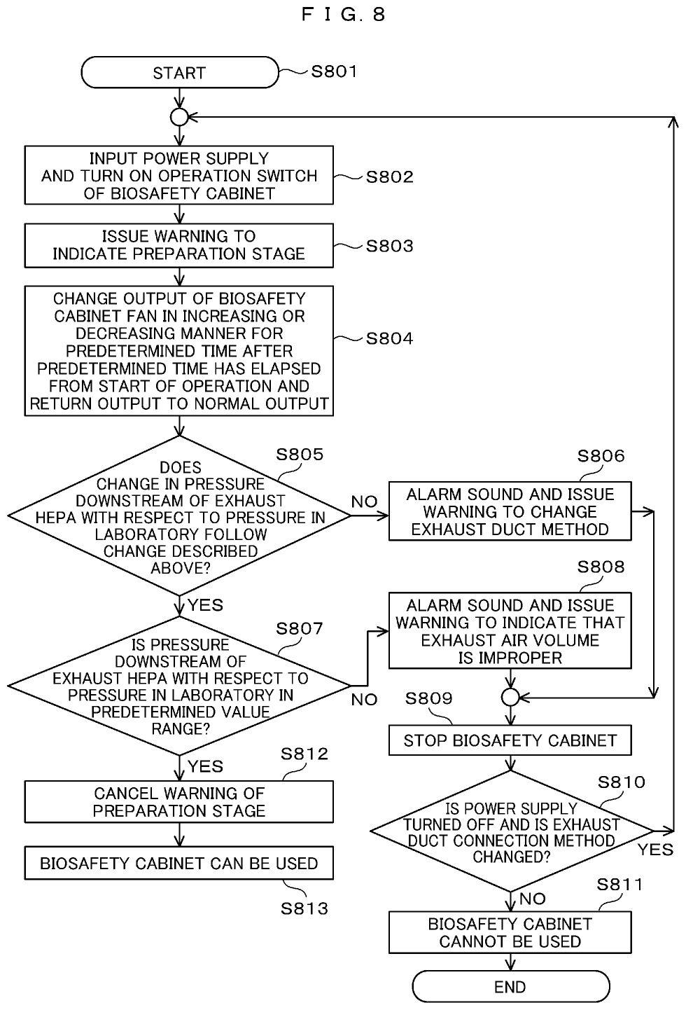

FIG. 8 is an example of a flowchart for determining outdoor exhaust through the sealed duct connection based on a pressure. The flowchart is an example of determination of an exhaust duct connection method, which includes part of operations. The flowchart is an example of a determination procedure, and is not a flowchart of operation of the apparatus.

Since a volatile hazardous substance is used in an experiment in a class II B1 type or class II B2 type biosafety cabinet, outdoor exhaust through the sealed duct connection is essential.

The start of determination is initiated (S801). The power supply is input to the biosafety cabinet, and the operation switch is turned on. The biosafety cabinet fan 106 is activated, but proper airflows are not immediately formed in the biosafety cabinet 100, and thus similar to Example 2, a warning to indicate a preparation stage is issued with a display lamp or the like (S803).

Similar to Example 2, after a predetermined time, for example, 30 seconds or one minute has elapsed from the start of operation, an output of the biosafety cabinet fan 106 decreases only for 10 seconds to 50% of the output required by the biosafety cabinet, and thereafter, returns back to the output required by the biosafety cabinet (S804). The change in the output may not be 50% but be 30%, 150%, or the like.

It is determined whether the exhaust duct connection method is the open duct connection or the sealed duct connection, based on a difference between the pressure of the exhaust HEPA filter downstream pressure measurement port 120a when the biosafety cabinet fan 106 operates and the pressure of the laboratory in which the biosafety cabinet 100 is disposed. In addition, it is determined whether or not air is independently exhausted for each one of the biosafety cabinets.

Similar to Example 2, if the open duct connection is made, even though the output of the biosafety cabinet fan 106 decreases or increases for a predetermined time, since the open duct opening 117a is provided, the pressure downstream of the exhaust HEPA filter with respect to the pressure in the laboratory does not follow a change in the output. In this case, it is determined that the open duct connection is made. Since in the class II B2 type, the open duct connection is improper, an alarm is sounded and a warning is issued to instruct the change of the exhaust duct method (S806). As illustrated in FIG. 3, also when one outdoor exhaust duct 115 and one outdoor exhaust fan 116 are provided for a plurality of the class II B2 type biosafety cabinets, since exhaust air of one biosafety cabinet 100 flows through the exhaust duct connected to another biosafety cabinet 100, the same phenomenon occurs. As described above, also when the biosafety cabinet 100 does not alone perform outdoor exhaust, an alarm for an improper exhaust duct connection is issued.

If a change in the pressure follows a change in the output of the biosafety cabinet fan 106, it is determined that the sealed duct connection proper for the class II B2 type biosafety cabinet 100 is made.

Subsequently, based on the value of the pressure downstream of the exhaust HEPA filter with respect to the pressure in the laboratory, it is determined whether or not the exhaust air volume is proper (S807). Since it is necessary to perform outdoor exhaust construction at the installation of the class II B2 type biosafety cabinet 100, a region downstream of the exhaust HEPA filter has a predetermined pressure, which is required to maintain the performance, with respect to the pressure in the laboratory. The pressure may be 0 Pa or minus several hundreds of Pa depending on a structure of the biosafety cabinet 100. If it is determined that the pressure of the exhaust HEPA filter downstream pressure measurement port 120a which is detected by the differential pressure gauge 120 is in a predetermined value range with respect to the pressure required to maintain the performance, it is determined that the exhaust air volume is proper. If the pressure deviates from the predetermined value, it is determined that the exhaust air volume is improper, and an alarm is issued (S808). The predetermined value range is a value range required to maintain the performance of the biosafety cabinet 100, which is determined by a manufacturer.

The description has been given with the class II B2 type; however, the fact that the sealed duct connection is essential applies to also the class II B1 type.

In the biosafety cabinet of the present example, after decreasing or increasing an output of the air blowing means for a predetermined time within a predetermined time from an activation of the air blowing means (the biosafety cabinet fan 106), the control unit 130 returns the output back to an output before change, and if a change in a pressure detected by the pressure detection means (the differential pressure gauge 120) does not follow a change in the output of the air blowing means, the control unit 130 determines that a proper sealed duct connection is not made, and if the pressure detected by the pressure detection means (the differential pressure gauge 120) is not in the predetermined value range, the control unit 130 determines that the exhaust air volume is improper, and the alarm unit issues a warning to indicate that air is improperly exhausted.

According to the present example, at the preparation stage of operation of the biosafety cabinet, it is possible to detect that the outdoor exhaust duct connection is the open duct connection, or that the exhaust air volume of the sealed duct connection is improper, and at an initial stage of installation of the biosafety cabinet, it is possible to issue a warning to indicate that an improper exhaust duct connection is made.

### EXAMPLE 5

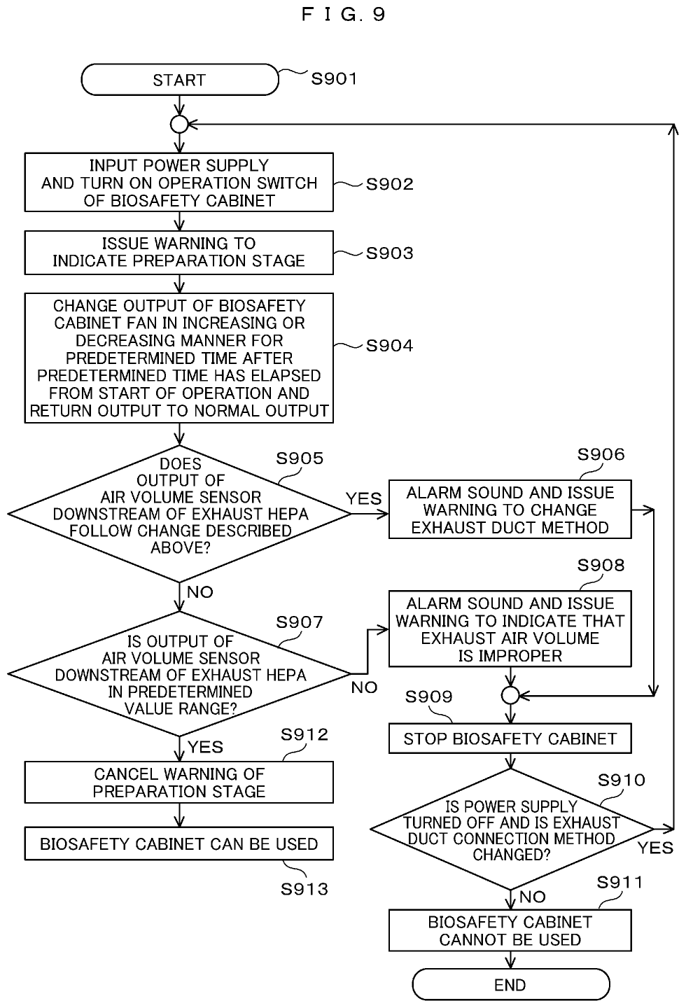

FIG. 9 is an example of a flowchart for determining outdoor exhaust through the sealed duct connection based on an air volume. The flowchart is an example of determination of an exhaust duct connection method, which includes part of operations. The flowchart is an example of a determination procedure, and is not a flowchart of operation of the apparatus.

Since a volatile hazardous substance is used in an experiment in a class II B1 type or class II B2 type biosafety cabinet, outdoor exhaust through the sealed duct connection is essential.

Similar to Example 4, the output of the biosafety cabinet fan 106 is changed in an increasing or decreasing manner for a predetermined time from the start of operation of the biosafety cabinet 100 (S904). If an output of the air volume sensor 121 disposed downstream of the exhaust HEPA filter follows the output of the biosafety cabinet fan 106, it is determined that the exhaust of the biosafety cabinet 100 leaks from the open portion 117a of the open duct connection, or, as illustrated in FIG. 3, that the exhaust flows through the exhaust duct connected to another biosafety cabinet 100 since the plurality of biosafety cabinets 100 are connected in common to the outdoor exhaust duct 116, and an alarm for an improper exhaust duct connection is issued (S906).

If a change in the output of the air volume sensor 121 does not follow a change in the output of the biosafety cabinet fan 106, since the exhaust of one biosafety cabinet 100 is connected to the outdoor exhaust duct 116 and the outdoor exhaust fan 115 which are exclusive, it is determined that the sealed duct connection where the air volume of the outdoor exhaust fan 115 is dominant is made, and it is determined that construction is properly performed.

Subsequently, it is determined whether or not the value of the output of the air volume sensor 121 is proper (S907). The class II B2 type biosafety cabinet 100 has an exhaust air volume passing through the exhaust HEPA filter which is required to maintain the performance. If it is determined that the value of the output of the air volume sensor 121 is in a predetermined value range with respect to the exhaust air volume required to maintain the performance, it is determined that the exhaust duct connection is proper (S912 and S913). If the value of the output deviates from the predetermined value, it is determined that the exhaust air volume is improper, and an alarm is issued (S908). The predetermined value range is a value range required to maintain the performance of the biosafety cabinet 100, which is determined by a manufacturer.

The description has been given with the class II B2 type; however, the fact that the sealed duct connection is essential applies to also the class II B1 type.

In the biosafety cabinet of the present example, after decreasing or increasing an output of the air blowing means for a predetermined time within a predetermined time from an activation of the air blowing means (the biosafety cabinet fan 106), the control unit 130 returns the output back to an output before change, and if the output of the air volume detection means (the air volume sensor 121) does not follow a change in the output of the air blowing means, the control unit 130 determines that a proper sealed duct connection is not made, and if the output of the air volume detection means is not in the predetermined value range, the control unit 130 determines that the exhaust air volume is improper, and the alarm unit issues a warning to indicate that air is improperly exhausted.

According to the present example, similar to Example 4 at the preparation stage of operation of the biosafety cabinet, it is possible to detect that the outdoor exhaust duct connection is the open duct connection, or that the exhaust air volume of the sealed duct connection is improper, and at an initial stage of installation of the biosafety cabinet, it is possible to issue a warning to indicate that an improper exhaust duct connection is made.

### REFERENCE SIGNS LIST

100 Biosafety cabinet
100a Biosafety cabinet in operation
100b Biosafety cabinet in stop state
101 Operation bed surface
102 Operation space
103 Front shutter
104 Operation opening
104a Front grille
105 Back flow path
105a Rear grille
106 Biosafety cabinet fan
107 Air blow rectifier plate
108 Biosafety cabinet exhaust port
109 Pressure chamber
110 Exhaust HEPA filter
111 Air blow HEPA filter
112 Inlet airflow
113 Blowing airflow
114 Biosafety cabinet exhaust air
115 Building exhaust fan
116 Building exhaust duct
117 Open duct
117a Open duct opening
118 Open duct opening intake air
119 Sealed duct
120 Differential pressure gauge
120a Exhaust HEPA filter downstream pressure measurement port
120b Exhaust HEPA filter upstream pressure measurement port
121 Air volume sensor
122 Shared duct
123 Dust, aerosol (including pathogens or the like)
124 Backflow
125 Damper
125a Damper
125b Damper
128 Operation unit
130 Control unit
132 Alarm unit

1. A biosafety cabinet which includes first air purification means for exhausting air, second air purification means for supplying purified air to an operation space, and air blowing means, in which the purified air is supplied from the second air purification means to the operation space and the air is exhausted from the first air purification means, the cabinet comprising:
an opening connected to an exhaust duct that is provided downstream of the first air purification means;
pressure detection means or air volume detection means disposed downstream of the first air purification means;
a control unit controlling an operation of the air blowing means; and
an alarm unit,
wherein the control unit determines an exhaust duct connection method based on an output of the pressure detection means or the air volume detection means and an operation state of the air blowing means, and
wherein if the exhaust duct connection method is improper, the alarm unit issues a warning.

2. The biosafety cabinet according to claim 1,
wherein the pressure detection means is formed of a pressure measurement port downstream of the first air purification means, a pressure measurement port upstream of the first air purification means, and a differential pressure gauge that is connected between the downstream pressure measurement port and the upstream pressure measurement port.

3. The biosafety cabinet according to claim 1,
wherein the air volume detection means is an air volume sensor or an air speed sensor.

4. The biosafety cabinet according to claim 1,
wherein if when the air blowing means stops, a pressure downstream of the first air purification means with respect to a pressure upstream thereof or a pressure in a laboratory decreases below a predetermined threshold value, the control unit determines that a sealed duct connection is made, and
wherein the alarm unit issues a warning.

5. The biosafety cabinet according to claim 1,
wherein if when the air blowing means stops, the output of the air volume detection means increases above a predetermined threshold value, the control unit determines that a sealed duct connection is made, and
wherein the alarm unit issues a warning.

6. The biosafety cabinet according to claim 1,
wherein the control unit determines a duct connection method by decreasing or increasing an output of the air blowing means for a predetermined time within a predetermined time from an activation of the air blowing means, and then returning the output back to an output before change and comparing a change in a pressure detected by the pressure detection means with a change in the output of the air blowing means.

7. The biosafety cabinet according to claim 6,
wherein if the change in the pressure detected by the pressure detection means follows the change in the output of the air blowing means, the control unit determines that a sealed duct connection is made, and
wherein the alarm unit issues a warning.

8. The biosafety cabinet according to claim 1,
wherein the control unit determines a duct connection method by decreasing or increasing an output of the air blowing means for a predetermined time within a predetermined time from an activation of the air blowing means, and then returning the output back to an output before change and comparing a change in the output of the air volume detection means with a change in the output of the air blowing means.

9. The biosafety cabinet according to claim 8,
wherein if the change in the output of the air volume detection means follows the change in the output of the air blowing means, the control unit determines that a sealed duct connection is made, and
wherein the alarm unit issues a warning.

10. The biosafety cabinet according to claim 1,
wherein after decreasing or increasing an output of the air blowing means for a predetermined time within a predetermined time from an activation of the air blowing means, the control unit returns the output back to an output before change, and if a change in a pressure detected by the pressure detection means does not follow a change in the output of the air blowing means, the control unit determines that a proper sealed duct connection is not made, and if the pressure detected by the pressure detection means is not in a predetermined value range, the control unit determines that an exhaust air volume is improper, and
wherein the alarm unit issues a warning to indicate that air is improperly exhausted.

11. The biosafety cabinet according to claim 1,
wherein after decreasing or increasing an output of the air blowing means for a predetermined time within a predetermined time from an activation of the air blowing means, the control unit returns the output back to an output before change, and if the output of the air volume detection means does not follow a change in the output of the air blowing means, the control unit determines that a proper sealed duct connection is not made, and if the output of the air volume detection means is not in a predetermined value range, the control unit determines that an exhaust air volume is improper, and
wherein the alarm unit issues a warning to indicate that air is improperly exhausted.

12. The biosafety cabinet according to claim 1,
wherein the pressure detection means disposed downstream of the first air purification means or the air volume detection means disposed downstream of the first air purification means is disposed on a first air purification means side of the opening.

13. An inspection method of an exhaust duct connection of a biosafety cabinet which includes first air purification means for exhausting air, second air purification means for supplying purified air to an operation space, and air blowing means, in which the purified air is supplied from the second air purification means to the operation space and the air is exhausted from the first air purification means, the method comprising:
a step of detecting a pressure or an air volume downstream of the first air purification means with pressure detection means or air volume detection means, which is disposed downstream of the first air purification means, when an operation of the air blowing means stops;
a step of determining that a sealed duct connection is made, if a pressure detected by the pressure detection means decreases below a predetermined pressure threshold value or if an air volume detected by the air volume detection means increases above a predetermined threshold value; and
a step of issuing a warning to indicate an exhaust duct connection method is improper.

14. An inspection method of an exhaust duct connection of a biosafety cabinet which includes first air purification means for exhausting air, second air purification means for supplying purified air to an operation space, and air blowing means, in which the purified air is supplied from the second air purification means to the operation space and the air is exhausted from the first air purification means, the method comprising:
a step of decreasing or increasing an output of the air blowing means for a predetermined time within a predetermined time from an activation of the air blowing means, and then returning the output back to an output before change;
a step of detecting a pressure or an air volume downstream of the first air purification means with pressure detection means or air volume detection means disposed downstream of the first air purification means;
a step of determining an exhaust duct connection method by comparing a change in an output of the pressure detection means or a change in an output of the air volume detection means with a change in the output of the air blowing means and by determining whether or not the change in the output of the pressure detection means or the change in the output of the air volume detection means follows the change in the output of the air blowing means; and
a step of issuing a warning if the exhaust duct connection method is improper.

15. The inspection method of an exhaust duct connection of a biosafety cabinet according to claim 14, further comprising:
a step of determining whether or not the pressure or the air volume downstream of the first air purification means, which is detected by the pressure detection means or the air volume detection means, is in a predetermined threshold value; and
a step of issuing a warning to indicate that an exhaust air volume is improper, if the pressure or the air volume downstream of the first air purification means is not in the predetermined value range.
